(19) United States
(12) Patent Application Publication
(10) Pub. No.: US 2009/0038821 A1
(43) Pub. Date: Feb. 12, 2009

(54) COVERED ELECTRIC WIRE AND COAXIAL CABLE

(75) Inventors: Megumi SATO, Osaka (JP); Takahiro KITAHARA, Osaka (JP)

Correspondence Address: SUGHRUE MION, PLLC, 2100 PENNSYLVANIA AVENUE, N.W., SUITE 800, WASHINGTON, DC, 20037, US

(73) Assignee: DAIKIN INDUSTRIES, LTD., Osaka (JP)

(21) Appl. No.: 12/187,001

(22) Filed: Aug. 6, 2008

(30) Foreign Application Priority Data
Aug. 8, 2007 (JP) 2007-207086

(51) Int. Cl. H01B 3/30; C08F 16/24; H01B 7/00

(52) U.S. Cl. 174/120 R; 526/247; 521/149; 174/110 SR

(57) ABSTRACT

The present invention provides a covered electric wire having a covering excellent in electrical characteristics and thermal stability as well as in crack resistance. The present invention is related to a covered electric wire comprising a core wire covered with a tetrafluoroethylene [TFE]-based copolymer comprising TFE-derived TFE units and perfluoro (alkyl vinyl ether) [PAVE]-derived PAVE units, a content of said PAVE unit being in excess of 5% by mass and not higher than 20% by mass relative to all monomer units, containing less than 10 unstable terminal groups per 1×10⁶ carbon atoms, and having a melting point of not lower than 260° C.

### TECHNICAL FIELD

The present invention relates to a covered electric wire and a coaxial cable.

### BACKGROUND ART

Tetrafluoroethylene [TFE]-based copolymers, in particular TFE/perfluoro (alkyl vinyl ether) [PAVE] copolymers [PFAs], are excellent in thermal stability, chemical resistance and electrical characteristics, among others, and therefore are used as molding materials or covering/coating materials for various products.

Among PFA-based molding materials, those PFA species which has a PAVE monomer unit content of 1.9 to 5.0 mole percent, an MFR of 35 to 60 g/10 minutes and a weight average molecular weight/number average molecular weight ratio of 1 to 1.7 have been proposed as species excellent in mechanical characteristics and injection moldability (e.g. Patent Document 1).

Among PFA-based molding materials, those PFA species which have an MFR of 0.1 to 50 g/10 minutes, a PAVE monomer unit content of not lower than 3.5 mole percent, a melting point of not lower than 295° C. and an unstable terminal group content of not higher than 50 per 1×10⁶ carbon atoms have been proposed as ones excellent in ozone resistance (e.g. Patent Document 2).

As PFA-based covering/coating materials, there may be mentioned covering/coating materials for covered electric wires and coaxial cables.

Among such covering/coating materials, those PFE/PPVE copolymers which have a PPVE monomer unit content of about 5% or lower (e.g. Patent Document 3) and those PFAs which have a PAVE-derived PAVE unit content of higher than 5% by mass but not higher than 10% by mass and contain 10 to 100 unstable terminal groups per 1×10⁶ carbon atoms (e.g. Patent Document 4), for example, may be mentioned as species which are low in dielectric loss tangent.

Further, foamed PFAs having a PAVE unit content of 1 to 20% by weight and amelt viscosity, at 372° C., of 10² to 10⁷ poises and contain the fluoride ion extractable with a specific methanol-water mixture in an amount of not larger than 1.5 ppm on the weight basis have been proposed as insulating layers for coaxial cables small in dielectric loss tangent (e.g. Patent Document 5).

TFE/PEVE copolymers having a perfluoro(ethyl vinyl ether) [PEVE]-derived PEVE unit content of at least 3% by weight and a melt viscosity of 0.5×10³ to 25×10³ Pa·s (e.g. Patent Document 6) and PFA species having a PAVE unit content of about 1.9 to 4.5 mole percent and a melt flow rate [MFR] exceeding 60 g/10 minutes (e.g. Patent Document 7), among others, have been proposed as covering/coating materials having good extrudability.

PFA species having a perfluoro(propyl vinyl ether) [PPVE]-derived PPVE unit content of about 2.5 to 15 mole percent, a volume flow rate of 0.1 to 20 mm³/second at 380° C. and an MIT fold number (folding endurance) of at least 3 million times (e.g. Patent Document 8) have been proposed as covering/coating materials having good thermal stability.

Meanwhile, as regards electromagnetic wave transmitting parts, higher and higher frequency bands have been employed hand in hand with current trends toward increases in speed and mass of information communications. Generally, transmission losses (attenuations) increase as the frequency employed becomes higher and, therefore, insulating materials causing smaller transmission loses than in the conventional art are required as materials for use in high frequency bands. Further, as a result of sophistication and diversification of telecommunication devices and equipment, information terminals and medical devices and instruments, thinner and thinner cables have been employed; as is known, however, transmission losses increase as the cable diameter decreases. Thin cables high in power capacity, easy to handle even in narrow spaces and excellent in crack resistance are required.

In the case of PFA-based covering/coating materials, however, low PAVE monomer unit content levels are preferred for improvements in electrical characteristics and thermal stability, whereas relatively high PAVE monomer unit contents are preferred from the improved crack resistance viewpoint. Thus, it is difficult to obtain covering/coating materials excellent not only in electrical characteristics and thermal stability but also in crack resistance.
[Patent Document 1] Japanese Kokai Publication 2002-53620
[Patent Document 2] International Laid-open Publication 2003/048214
[Patent Document 3] Japanese Kokai Publication H03-184209
[Patent Document 4] Japanese Kokai Publication 2005-298659
[Patent Document 5] Japanese Kokai Publication 2005-78835
[Patent Document 6] Japanese Kohyo Publication 2002-509557
[Patent Document 7] International Laid-open Publication 2005/052015
[Patent Document 8] Japanese Kokai Publication 2006-66329

### DISCLOSURE OF INVENTION

Problems which the Invention is to Solve

In view of the above-discussed state of the art, it is an object of the present invention to provide a covered electric wire having a covering excellent in electrical characteristics and thermal stability as well as in crack resistance.

### Means for Solving the Problems

The present invention provides a covered electric wire comprising a core wire covered with a tetrafluoroethylene [TFE]-based copolymer comprising TFE-derived TFE units and perfluoro(alkyl vinyl ether) [PAVE]-derived PAVE units, a content of the PAVE unit being in excess of 5% by mass and not higher than 20% by mass relative to all monomer units, containing less than 10 unstable terminal groups per 1×10⁶ carbon atoms, and having a melting point of not lower than 260° C.

The invention also provides a coaxial cable, wherein a covered electric wire defined as above-mentioned is further covered with an outer layer.

In the following, the invention is described in detail.

The covered wire of the invention is characterized in that the covering layer thereof comprises a TFE-based copolymer improved in crack resistance while maintaining thermal stability and dielectric loss tangent as a result of adjustment of the PAVE unit content and further improved in thermal stability and electric characteristics as a result of restriction of the number of unstable terminal groups.

It was found:

That such a TFE-based copolymer as mentioned above is improved in melt processability and crack resistance when the PAVE unit content is increased to a level exceeding 5% by mass relative to all monomer units;

That when PAVE unit content is not higher than 20% by mass relative to all monomer units and the melting point is not lower than 260° C., no significant decreases in thermal stability and electrical characteristics are observed; and

That when the number of unstable terminal groups is reduced to a level smaller than 10 per 1×10⁶ carbon atoms, the TFE-based copolymer acquires a stable structure and the thermal stability and electrical characteristics thereof are improved and, in addition, the unstable terminal group-due gas formation, presumably a cause of void formation, will hardly occur on the occasion of core wire covering. Thus, the above-defined covered electric wire has been completed by using such copolymer as the covering layer.

While PFAs having a PAVE unit content of 5% by mass or higher relative to all monomer units have so far been considered to be inferior in thermal stability and electrical characteristics (cf. Patent Document 3), the TFE-based copolymer according to the present invention is low in dielectric loss tangent and excellent in thermal stability in spite of the PAVE unit content exceeding 5% by mass relative to all monomer units.

In accordance with the invention, the above-mentioned TFE-based copolymer is a copolymer comprising TFE units and PAVE units.

The term “monomer unit” as used herein referring to “TFE unit” or “PAVE unit”, among others, means that constituent part derived from the monomer used which is a part of the molecular structure of the copolymer. The term “all monomer units” as used herein means all parts derived from all monomers used in the molecular structure of the copolymer.

The respective monomer unit contents mentioned above are values determined by carrying out ¹⁹F-NMR measurements at a measurement temperature of (melting point of polymer +20)° C. using a model AC300 nuclear magnetic resonance spectrometer (product of Bruker-Biospin), followed by integration of the respective peaks.

The PAVE for constituting the above-mentioned PAVE units is not particularly restricted but includes, among others, perfluoro(methyl vinyl ether) [PMVE], perfluoro(ethyl vinyl ether) [PEVE], perfluoro(propyl vinyl ether) [PPVE], perfluoro(butyl vinyl ether), perfluoro(pentyl vinyl ether), perfluoro(hexyl vinyl ether) and perfluoro(heptyl vinyl ether). Among them, PPVE is preferred in view of its copolymerizability with TFE and from the thermal stability viewpoint, and PMVE is preferred in view of its copolymerizability with TFE.

The TFE-based copolymer mentioned above is one in which the above-mentioned PAVE unit content is in excess of 5% by mass relative to all monomer units but is not higher than 20% by mass on the same basis. At content levels not higher than 5% by mass, the crack resistance may sometimes become decreased and, at levels exceeding 20% by mass, the thermal stability and/or electrical characteristics may sometimes be inferior.

A preferred lower limit to the PAVE unit content is 5.5% by mass, a more preferred lower limit thereto is 6% by mass, a preferred upper limit thereto is 10% by mass, and a more preferred upper limit thereto is below 8% by mass, relative to all monomer units.

The TFE-based copolymer mentioned above is required to be one such that the sum of TFE units and PAVE units account for at least 90% by mass of all monomer units; thus, it may be a copolymer resulting from copolymerization with another monomer or other monomers copolymerizable therewith within limits within which the characteristic features of the invention will not be impaired.

As such copolymerizable monomers, there may be mentioned, for example, hexafluoropropylene [HFP] and chlorotrifluoroethylene.

The number of unstable terminal groups contained in the above-mentioned TFE-based copolymer is less than 10 per 1×10⁶ carbon atoms. When the number of unstable terminal groups is 10 or more per 1×10⁶ carbon atoms, the thermal stability and electrical characteristics may become inferior in some instances.

In the present specification, the term “unstable terminal groups” means —COF, —COOH, —COOCH₃, —CONH₂ and —CH₂OH occurring at main chain termini.

The unstable terminal groups mentioned above are chemically unstable and, therefore, not only lower the thermal stability of the resin but also cause the electric wire obtained to show increased attenuation. Furthermore, the above-mentioned unstable terminal groups may generate gases such as HF upon thermal degradation and such gases sometimes cause the formation of voids. Therefore, it is considered that when the number of unstable terminal groups is large, unstable terminal group-derived gases may be generated on the occasion of core conductor covering and these gases will impair the adhesion of the resin to the core conductor.

The number of the above-mentioned unstable terminal groups is preferably less than 5, more preferably 2 or less, per 1×10⁶ carbon atoms. The above-mentioned unstable terminal groups may be absent.

In the present specification, the number of unstable terminal groups is the value determined by subjecting an about 0.35-mm-thick film obtained by press-molding the sample at room temperature to infrared absorption spectrometry using a Fourier transform infrared spectrophotometer [FT-IR] (trade name: FI-IR Spectrometer 1760X, product of Perkin Elmer) and making calculations based on the difference spectrum from the base spectrum obtained by using the corresponding resin containing no unstable terminal groups.

From the further improved crack resistance viewpoint, the above-mentioned TFE-based copolymer preferably has a melt flow rate [MFR] of not higher than 60 g/10 minutes, more preferably not higher than 35 g/10 minutes. Within the above range, the MFR is generally required to be not lower than 0.5 g/10 minutes.

In the case of TFE/PPVE copolymers, the above MFR is the value measured in accordance with ASTM D 1238 using a DYNISCO MELT FLOW INDEX TESTER (product of Yasuda Seiki Seisakusho) under conditions of a temperature of 372° C. and a load of 5 kgf.

Actually, as the covering/coating materials of the coaxial cable for high frequency bands, low dielectric loss tangent levels of the TFE copolymers are preferred for decreasing transmission attenuations. For decreasing transmission attenuations, PAVE unit content of the TFE copolymers is preferred not higher than 20% by mass relative to all monomer units, in addition that the number of above-mentioned unstable terminal groups is small. When the PAVE is PPVE, a preferred upper limit is 8% by mass. When the PAVE is PMVE, a preferred upper limit is 10% by mass.

The above-mentioned TFE-based copolymer generally has a melting point of not lower than 260° C. A preferred lower limit to the melting point is 280° C., a more preferred lower limit is 298° C. and, within the above range, the melting point may be 308° C. or lower. By restricting the PAVE unit content to the range given above, it becomes possible for the above TFE-based copolymer to have a melting point within the range mentioned above.

In the present specification, the melting point is the value determined based on the peak in the endothermic curve obtained by carrying out calorimetry in accordance with ASTM D 4591 using a model RDC 220 differential scanning calorimeter (product of Seiko Instruments) at a programming rate of 10° C./minute.

The above-mentioned TFE-based copolymer can be obtained, for example, by a process comprising (1) the step of polymerizing TFE and a PAVE, if necessary together with another monomer and (2) the step of subjecting the copolymer obtained to fluorination treatment to reduce the number of unstable terminal groups in that copolymer to a level lower than 10 per 1×10⁶ carbon atoms.

The polymerization in the above step (1) can be carried by any of the known methods, such as emulsion polymerization and suspension polymerization, but is preferably carried out in the manner of suspension polymerization. So long as a PAVE is added in an amount such that the PAVE unit content of the copolymer obtained may be within the range specified above, the other polymerization conditions, such as temperature and pressure, can be properly selected depending on the reaction scale and other factors in the same manner as in the conventional methods.

On the occasion of the above polymerization, a polymerization initiator capable of giving a terminal —CF₃ group(s) under appropriate conditions maybe used. In this case, the step (2) can be simplified or omitted.

As such polymerization initiator, there may be mentioned, for example, perfluoroalkyl peroxides such as (CF₃(CF₂)ₙ—O)₂ (n being an integer of 1 to 9), perfluorodiacyl peroxides such as (CF₃(CF₂)ₙ—COO)₂ (n being an integer of 1 to 9) and (C₃F₇—O—CF(CF₃)—COO)₂, stable perfluoroalkyl radical such as ((CF₃)₂CF)₂(CF₃CF₂)C., difluoroamines such as C₃F₇—C(CF₃)NF₂, perfluoroazo compounds such as N₂F₂ and ((CF₃)₂CFN)₂, perfluorosulfonyl azides such as CF₃SO₂N₃, perfluoroacid chlorides such as C₃F₇COCl, and perfluoroalkyl hypofluorite such as CF₃OF.

The copolymer obtained by the above polymerization may be subjected to such known after-treatment(s) as concentration, coagulation or/and drying. For efficiently reducing the number of unstable terminal groups in the above step (2), this copolymer is preferably prepared in the form of a powder, granules or pellets, more preferably in the form of pellets.

The pelletization can be carried out in the manner known in the art, for example by melt extrusion; the extrusion temperature is not particularly restricted but preferably is 280 to 420° C.

The method of fluorination treatment in the above step (2) is not particularly restricted but mention may be made of the method comprising exposing the copolymer obtained in step (1) to a fluoride radical source capable of generating fluoride radicals under fluorination treatment conditions.

As the fluoride radical source, there may be mentioned fluorine gas, CoF₃, AgF₂, UF₆, OF₂, N₂F₂, CH₃OF, and halogen fluorides such as IF₅ and ClF₃, among others.

When the method comprising bringing the copolymer obtained in step (1) into contact with fluorine gas is used for the above-mentioned fluorination treatment, it is preferred from the reaction controllability viewpoint that the contacting be carried out using a diluted fluorine gas with a fluorine gas concentration of 10 to 50% by mass. The diluted fluorine gas can be obtained by diluting fluorine gas with an inert gas such as nitrogen gas or argon gas.

Generally, the above fluorine gas treatment can be carried out at a temperature of 100 to 250° C. A preferred lower limit to the above temperature is 120° C. and a preferred upper limit is 230° C. The fluorine gas treatment is preferably carried out while feeding the diluted fluorine gas into the reaction vessel either continuously or intermittently.

The covered electric wire of the invention comprises a core wire or conductor covered with the TFE-based copolymer mentioned above. The core wire or conductor material is not particularly restricted but may be any of such electrically conductive materials as copper, aluminum and steel; among them, copper is preferred, however.

The diameter of the core wire is not particularly restricted but preferably is 0.03 to 1.00 mm. A more preferred lower limit to the core wire diameter is 0.05 mm.

The layer of the above-mentioned TFE-based copolymer covering the core (hereinafter, this layer is referred to as “covering layer”) preferably has a thickness of 0.03 to 4.78 mm.

The covering layer thickness mentioned above is the value obtained by measuring the outside diameter of the covered wire using a Laser Micrometer outside diameter measuring apparatus (product of Takikawa Engineering), subtracting the outside diameter of the core wire as measured in advance from the outside diameter of the covered wire and dividing the difference by 2.

The above-mentioned TFE-based copolymer can be used in covering the core wire in the conventional manner, for example by melt extrusion molding. The covering can be carried out by selecting the extruder size depending on the size of the desired covered electric wire and appropriately selecting the covering conditions such as drawdown ratio [DDR] and draw ratio balance [DRB] accordingly.

The covering can be carried out at a resin temperature of 280 to 420° C., although the temperature is not particularly restricted. Resin temperatures exceeding 420° C. readily cause decomposition of the resin and cause foaming and, therefore, undesirable. A preferred resin temperature is to be properly selected according to the melting point and MFR of the resin and the intended covered wire size.

The resin temperature, so referred to herein, is the temperature of the cylinder site of the extruder employed and the value thereof is obtained by inserting a spring type fixed thermocouple (product of Toyo Dennetsu) thereinto and measuring the cylinder inside temperature.

In the covered electric wire of the invention, the covering layer may be one obtained without causing foaming or one obtained by causing foaming. In the case of the covering layer being a foamed one, the covered electric wire can show further reduced transmission loss levels. The above-mentioned TFE-based copolymer, even when foamed, can still cover a thin core wire having a diameter smaller than 0.1 mm.

In the case of the above-mentioned covering layer being a foamed one, for example in the case of covering a core wire with an AWG of 35 or higher, it is preferred that the above-mentioned TFE-based copolymer have an MFR exceeding 35 g/10 minutes but not higher than 85 g/10 minutes, more preferably 60 to 80 g/10 minutes. In this case, it is possible to produce a covered electric wire low in transmission loss and excellent in thermal stability and crack resistance in spite of its being thin in diameter.

The foamed body mentioned above preferably has an extent of foaming of 10 to 80%. The foamed body preferably has an average foam diameter of 5 to 100 μm. In the present specification, the extent of foaming means the percentage of change in specific gravity before and after foaming and is the value obtained by measuring the difference, in percentage, between the specific gravity intrinsic to the material constituting the foamed body and the apparent specific gravity of the foamed body by the water replacement method, and the average foam diameter is the value calculated based on a photomicrograph of a section of the foamed body.

The covering layer can be foamed by any of the methods known in the art. As such methods, there may be mentioned (1) the method comprising preparing pellets of the TFE-based copolymer with a nucleating agent added and extrusion-molding the pellets while continuously introducing a gas thereinto, and (2) the method comprising extrusion-molding the TFE-based copolymer in a molten state in admixture with a chemical blowing agent to thereby cause gas generation as a result of decomposition of the chemical blowing agent to obtain foam. In the above method (1), the nucleating agent may be any of those known in the art, for example boron nitride [BN]. The gas mentioned above is, for example, chlorodifluoromethane, nitrogen, carbon dioxide, or a mixture of these. The chemical blowing agent to be used in the above method (2) is, for example, azodicarbonamide or 4,4′-oxybisbenzenesulfonyl hydrazide. The level of addition of the nucleating agent and the gas feeding rate in the above method (1) and the level of addition of the chemical blowing agent in the above method (2) and other various conditions in both the methods can be appropriately adjusted depending on the resin species and core wire species employed and the desired thickness of the covering layer.

The covered electric wire of the invention is excellent in electrical characteristic, so that the dielectric loss tangent is small and the attenuation is slight even in the case of high frequency transmission. Therefore, it can be used in various fields of utilization, for example in a circuit for high frequency transmission, as a coaxial cable for a base station or other communication system, a LAN cable, a flat cable or a like cable, and in such a high frequency transmission device as a small sized electronic device in a mobile phone or as a printed circuit board.

A coaxial cable obtained by providing the above-mentioned covered electric wire of the invention with a further outer layer or layers also constitutes an aspect of the present invention. The coaxial cable of the invention comprises the above-mentioned covered electric wire and, therefore, is low in dielectric loss tangent and can be suitably used as a high frequency transmitting part.

The outer layer in the coaxial cable of the invention is not particularly restricted but may be a conductive layer made of an outer conductor, for example a metal mesh, or a resin layer (sheath layer) made of a TFE unit-containing fluorine-containing copolymers such as a TFE/HFP type copolymer or a TFE/PAVE type copolymer, poly(vinyl chloride) [PVC], polyethylene or a like resin.

The coaxial cable mentioned above may be a cable consisting of the above-mentioned covered electric wire of the invention, an outer conductor layer made of a metal as formed around the covered wire and such a resin layer (sheath layer) as mentioned above surrounding the outer conductor layer.

The outer layer mentioned above can be formed in the conventional manner, for example by melt extrusion molding.

### EFFECTS OF THE INVENTION

The covered electric wire of the invention, which has the constitution described hereinabove, is excellent in electrical characteristics, so that the dielectric loss tangent is small and, therefore, even in the case of high frequency electromagnetic wave transmission, the attenuation is small. Further, the above-mentioned covered electric wire is excellent in thermal stability and crack resistance as well.

### BEST MODES FOR CARRYING OUT THE INVENTION

The following examples, inclusive of comparative examples, illustrate the present invention in further detail. These examples and comparative examples are, however, by no means limitative of the scope of the invention.

### (1) Copolymer Composition

¹⁹F-NMR measurements were carried out using a model AC 300 nuclear magnetic resonance spectrometer (product of Bruker-BioSpin) at a measurement temperature of (melting point of polymer +20)° C., and the composition was determined from the values obtained by integrating the respective peaks.

### (2) Melting Point

Calorimetry was carried out in accordance with ASTMD 4591 using a model RDC 220 differential scanning calorimeter (product of Seiko Instruments) at a programming rate of 10° C./minute, and the melting point was determined from the peak on the endothermic curve obtained.

### (3) MFR

The MFR measurement was carried out in accordance with ASTM D 1238 using a DYNISCO MELT FLOW INDEX TESTER (product of Yasuda Seiki Seisakusho).

As for the general measurement conditions, the resin was extruded at a temperature of 372° C. through an orifice having an inside diameter of 2 mm and a length of 8 mm under a load of 5 kgf, and the mass of the resin flowing out per 10 minutes was determined. In the case of the copolymer having a melting point lower than about 240° C. as described in a comparative example, the extrusion was carried out at a temperature of 265° C.

### (4) Number of Unstable Terminal Groups

An about 0.35-mm-thick film was prepared by press-molding pellets using a hydraulic press and subjected to analysis using a model 1760X FI-IR Spectrometer (product of Perkin Elmer).

A difference spectrum was produced in comparison with the spectrum of a standard sample (sufficiently fluorinated until a state of no more substantial difference in spectrum as compared with the preceding samples), the absorbance of each peak was read, and the number of unstable terminal groups per 1×10⁶ carbon atoms was calculated according to the formula given below.

Number of unstable terminal groups per 1×10⁶ carbon atoms=(I×K)/t(I: absorbance, K: correction factor, t: film thickness (in mm))

The correction factors (K) used for the respective unstable terminal groups are as follows.

—COF (1884 cm⁻¹) . . . 405

—COOH (1813 cm^{31 1}, 1775 cm⁻¹) . . . 455

—COOCH₃ (1795 cm⁻¹) . . . 355

—CONH₂ (3438 cm⁻¹) . . . 480

—CH₂OH (3648 cm⁻¹) . . . 2325

### (5) Dielectric Loss Tangent (tan δ)

Round column-shaped measurement specimens, 2.3 mm in diameter and 80 mm in length, were prepared by melt extrusion of the resin at (melting point of polymer +about 30° C.). These measurement specimens were subjected to electrical characteristic measurement at 2.45 GHz by the cavity resonator perturbation method using a network analyzer (product of Kanto Electronics Application and Development) (testing temperature 25° C.).

### (6) MIT Folding Endurance

Pressed sheets, 0.2 mm in thickness, were prepared by press molding and subjected to MIT folding endurance testing in accordance with ASTM D 2176. A model No. 307 MIT folding endurance tester (product of Yasuda Seiki Seisakusho) was used and the measurement conditions were as follows: testing temperature: 23° C., folding angle: left and right each 135 degrees, folding speed: 175 cpm.

The MIT fold number is an indicator of folding endurance. The higher this value is, the better the folding endurance is, hence the higher the crack resistance to mechanical stresses is.

### Comparative Example 1

A glass-lined autoclave (capacity: 174 L) equipped with a stirrer was charged with 26.6 kg of pure water. After sufficient purging of the inside gas with N₂, the autoclave was evacuated and charged with 30.4 kg of perfluorocyclobutane [C-318], 0.8 kg of methanol and 1.6 kg of perfluoro(propyl vinyl ether) [PPVE]. Then, the autoclave inside was maintained at 35° C. with stirring, tetrafluoroethylene [TFE] was fed thereinto under pressure until arrival of the inside pressure at 0.58 MPaG. The polymerization was initiated by adding 0.028 kg of a 50% methanol solution of di-n-propyl peroxydicarbonate [NPP] as a polymerization initiator. Since otherwise the pressure would drop with the progress of the polymerization, additional TFE and PPVE were continuously fed in a ratio such that the desired polymer composition might be obtained.

After 33 hours from the start of polymerization, the stirring was discontinued and, at the same time, the unreacted monomers and C-318 were discharged to thereby terminate the polymerization. The white powder in the autoclave was washed with water and dried at 150° C. for 12 hours to give a polymer product.

The polymer product obtained was melt-extruded at an extrusion temperature of 395° C. using a screw extruder (product of Ikegai Corporation); TFE-based copolymer pellets were thus produced.

The pellets obtained had the following copolymer composition, melting point, MFR (measuring temperature 372° C.) and number of unstable terminal groups per 1×10⁶ carbon atoms.
Copolymer composition: TFE/PPVE=93.4/6.6 (% by mass)
Melting point [Tm]: 302° C.
MFR: 15.2 g/10 minutes
Number of unstable terminal groups: 99 —CH₂OH groups, 31 —COF groups, 2 —COOH groups (unassociated), 55 —COOCH₃ groups and 3 —COOH groups (associated)

Using a 30 mm ø electric wire covering molding machine (product of Tanabe Plastics Machinery), the pellets obtained were submitted to covering/molding. The screw L/D ratio of the machine was 24, and the screw CR was 3. The molding conditions were: cylinder temperature C1: 300° C., C2: 350° C., C3: 370° C., adapter temperature: 380° C., head temperature: 380° C., die temperature: 380° C., screw velocity: 10rpm, take-offspeed: 6.8 m/minute. Thus, a 0.812 mm ø (AWG 20) silver-plated copper wire was covered to a covering layer thickness of 0.90 mm t so that the characteristic impedance might amount to 50±1Ω. This covered wire was jacketed with an about 0.2-mm-thick copper pipe to give a semirigid cable.

The semirigid cable obtained was measured for attenuation using a model HP8510C network analyzer (product of Hewlett Packard). The semirigid cable obtained showed an attenuation of 1.7 dB/m at 6 GHz or 2.4 dB/m at 10 GHz.

### Example 1

The pellets obtained in Comparative Example 1 were placed in a model VVD-30 vacuum vibration reaction apparatus (product of Ookawara Manufacturing) and heated to 200° C. After evacuation, F₂ gas diluted to 20% by mass with N₂ gas was introduced until arrival at atmospheric pressure.

Three hours after the F₂ gas introduction, the reactor was once evacuated and then F₂ gas was again introduced into the reactor. The above-mentioned F₂ gas introduction and evacuation procedure was repeated 6 times in total. After completion of the reaction, the reactor inside was filled with N₂ gas, and the pellets were degassed at a temperature of 180° C. for 12 hours.

The pellets obtained had the following copolymer composition, melting point, MFR (measuring temperature 372° C.) and number of unstable terminal groups per 1×10⁶ carbon atoms.
Copolymer composition: TFE/PPVE=93.4/6.6 (% by mass)
Melting point [Tm]: 302° C.
MFR: 17.3 g/10 minutes
Number of unstable terminal groups: below detection limit.

Electric wire covering was carried out using the pellets obtained in Example 1, under the same conditions as in Comparative Example 1 except that the take-off speed was 7.1 m/minute to give a semirigid cable. The semirigid cable obtained was measured for attenuation in the same manner as in Comparative Example 1; the attenuation was 1.2 dB/m at 6 GHz or 1.6 dB/m at 10 GHz.

### Example 4

A TFE-based copolymer was prepared in the same manner as in Example 1 except that the F₂ gas introduction and evacuation procedure was repeated 5 times.

The pellets obtained had an MFR (measuring temperature 372° C.) of 17.3 g/10 minutes and, as unstable terminal groups, 5 —COF groups per 1×10⁶ carbon atoms.

Using a 30 mm ø electric wire covering molding machine, the pellets subjected to fluorination reaction were submitted to covering/molding. Electric wire covering was carried out using the pellets obtained, under the same conditions as in Comparative Example 1 except that the take-off speed was 7.1 m/minute to give a semirigid cable. The semirigid cable obtained was measured for attenuation using a model HP8510C network analyzer (product of Hewlett Packard). The semirigid cable obtained showed an attenuation of 1.2 dB/m at 6 GHz or 1.6 dB/m at 10 GHz.

### Comparative Production Example 1

A TFE-based copolymer was prepared in the same manner as in Example 1 except that the F₂ gas introduction and evacuation procedure was repeated four times.

The pellets obtained had an MFR (measuring temperature 372° C.) of 17.1 g/10 minutes and, as unstable terminal groups, 20 —COF groups per 1×10⁶ carbon atoms.

### Comparative Production Example 2

The pellets obtained in Comparative Production Example 1 were placed in a model VVD-30 vacuum vibration reaction apparatus (product of Ookawara Manufacturing) and, further, NH₃ gas was passed therethrough and the reaction was carried out at 70° C. for 5 hours. As a result of terminal group determination by IR, about 20 —CONH₂ groups per 1×10⁶ carbon atoms were found.

### Comparative Production Example 3

A glass-lined autoclave (capacity: 174 L) equipped with a stirrer was charged with 26.6 kg of pure water. After sufficient purging of the inside gas with N₂, the autoclave was evacuated and charged with 30.4 kg of C-318, 2.2 kg of methanol and 1.3 kg of PPVE. Then, the autoclave inside was maintained at 35° C. with stirring, TFE was fed thereinto under pressure until arrival of the inside pressure at 0.58 MPaG. The polymerization was initiated by adding 0.044 kg of a 50% methanol solution of NPP as a polymerization initiator. Since otherwise the pressure would drop with the progress of the polymerization, additional TFE and PPVE were continuously fed in a ratio such that the desired polymer composition might be obtained.

After 8 hours from the start of polymerization, the stirring was discontinued and, at the same time, the unreacted monomers and C-318 were discharged to thereby terminate the polymerization. The white powder in the autoclave was washed with water and dried at 150° C. for 12 hours to give a polymer product.

The above polymer product was pelletized under the same conditions as in Comparative Example 1.

The pellets obtained had the following copolymer composition, melting point, MFR (measuring temperature 372° C.) and number of unstable terminal groups per 1×10⁶ carbon atoms.
Copolymer composition: TFE/PPVE=95.6/4.4 (% by mass)
Tm: 304° C.
MFR: 13.7 g/10 minutes
Number of unstable terminal groups: 57 —CH₂OH groups, 45 —COF groups, 1 —COOH group (unassociated), 42 —COOCH₃ groups and 1 —COOH group (associated)

The pellets obtained were subjected to fluorination reaction in the same manner as in Example 1.

The pellets after fluorination reaction had an MFR (measuring temperature 372° C.) of 17.6 g/10 minutes; the number of unstable terminal groups was below the detection limit.

### Test Example 1

Pressed sheets were prepared using the pellets obtained in Example 1 or 4, Comparative Example 1 or Comparative Production Example 1, 2 or 3 and submitted to electrical characteristic (dielectric loss tangent) measurement and MIT testing. The results are shown in Table 1.

TABLE 1

| | | | | | Comparative | Comparative | Comparative |
|---|---|---|---|---|---|---|---|
| | | | | | Production | Production | Production |
| | | Comparative Example 1 | Example 1 | Example 4 | Example 1 | Example 2 | Example 3 |
| PPVE(% by mass) | | 6.6 | 6.6 | 6.6 | 6.6 | 6.6 | 4.4 |
| Tm(° C.) | | 302 | 302 | 302 | 302 | 302 | 304 |
| MFR(g/10 min) | 372° C. | 15.2 | 17.3 | 17.3 | 17.1 | 17.2 | 17.6 |
| Number of unstable terminal groups | | CH₂OH; 99 | below | COF; 5 | COF; 20 | CONH₂; 20 | below |
| per 1 × 10⁶ carbon atoms | | COF; 31 | detection limit | | | | detection limit |
| | | COOH(unassociated); 2 | | | | | |
| | | COOCH₃; 55 | | | | | |
| | | COOH(associated); 3 | | | | | |
| Dielectric loss tangent [2.45 GHz] | | 10.2 × 10⁻⁴ | 3.6 × 10⁻⁴ | 3.9 × 10⁻⁴ | 4.7 × 10⁻⁴ | 5.6 × 10⁻⁴ | 3.6 × 10⁻⁴ |
| MIT folding endurance [×10⁴ cycles] | | 11.0 | 11.8 | 11.7 | 11.5 | 11.3 | 6.2 |
| attenuation of cable | 6 GHz | 1.7 | 1.2 | 1.2 | — | — | — |
| (dB/m) | 10 GHz | 2.4 | 1.6 | 1.6 | — | — | — |

### Example 2

A glass-lined autoclave (capacity: 174 L) equipped with a stirrer was charged with 49.0 kg of pure water. After sufficient purging of the inside gas with N₂, the autoclave was evacuated and charged with 40.7 kg of C-318, 4.1 kg of methanol and 2.1 kg of PPVE. Then, the autoclave inside was maintained at 35° C. with stirring, TFE was fed thereinto under pressure until arrival of the inside pressure at 0.64 MPaG. The polymerization was initiated by adding 0.041 kg of a 50% methanol solution of NPP as a polymerization initiator. Since otherwise the pressure would drop with the progress of the polymerization, additional TFE and PPVE were continuously fed in a ratio such that the desired polymer composition might be obtained.

After 20 hours from the start of polymerization, the stirring was discontinued and, at the same time, the unreacted monomers and C-318 were discharged to thereby terminate the polymerization. The white powder in the autoclave was washed with water and dried at 150° C. for 12 hours to give a polymer product.

The above polymer product was pelletized under the same conditions as in Comparative Example 1. The pellets obtained had the following copolymer composition, melting point, MFR (measuring temperature 372° C.) and number of unstable terminal groups per 1×10⁶ carbon atoms.
Copolymer composition: TFE/PPVE=94.2/5.8 (% by mass)
Tm: 302° C.
MFR: 27.6 g/10 minutes
Number of unstable terminal groups: 146 —CH₂OH groups, 16 —COF groups, 2 —COOH groups (unassociated), 52 —COOCH₃ groups and 4 —COOH groups (associated)

The pellets obtained were subjected to fluorination reaction in the same manner as in Example 1. The pellets after fluorination reaction had an MFR (measuring temperature 372° C.) of 30.9 g/10 minutes; the number of unstable terminal groups was below the detection limit.

Using a 30 mm ø electric wire covering molding machine, the pellets after fluorination reaction were submitted to covering/molding. The electric wire covering was carried out in the same manner as in Comparative Example 1 and Example 1 except that the screw velocity was 8.5 rpm and the take-off speed was 6.5 m/minute; a semirigid cable was thus obtained. The semirigid cable obtained was measured for attenuation using a model HP8510C network analyzer (product of Hewlett Packard). The semirigid cable obtained showed an attenuation of 1.2 dB/m at 6 GHz or 1.6 dB/m at 10 GHz.

### Comparative Production Example 4

A glass-lined autoclave (capacity: 174 L) equipped with a stirrer was charged with 26.6 kg of pure water. After sufficient purging of the inside gas with N₂, the autoclave was evacuated and charged with 30.4 kg of C-318, 3.0 kg of methanol and 1.4 kg of PPVE. Then, the autoclave inside was maintained at 35° C. with stirring, TFE was fed thereinto under pressure until arrival of the inside pressure at 0.57 MPaG. The polymerization was initiated by adding 0.014 kg of a 50% methanol solution of NPP as a polymerization initiator. Since otherwise the pressure would drop with the progress of the polymerization, additional TFE and PPVE were continuously fed in a ratio such that the desired polymer composition might be obtained.

After 21 hours from the start of polymerization, the stirring was discontinued and, at the same time, the unreacted monomers and C-318 were discharged to thereby terminate the polymerization. The white powder in the autoclave was washed with water and dried at 150° C. for 12 hours to give a polymer product.

The above polymer product was pelletized under the same conditions as in Comparative Example 1. The pellets obtained had the following copolymer composition, melting point, MFR (measuring temperature 372° C.) and number of unstable terminal groups per 1×10⁶ carbon atoms.
Copolymer composition: TFE/PPVE=95.4/4.6 (% by mass)
Tm: 302° C.
MFR: 28.0 g/10 minutes
Number of unstable terminal groups: 120 —CH₂OH groups, 42 —COF groups, 2 —COOH groups (unassociated), 40 —COOCH₃ groups and 2 —COOH groups (associated)

The pellets obtained were subjected to fluorination reaction in the same manner as in Example 1. The pellets after fluorination reaction had an MFR (measuring temperature 372° C.) of 31.0 g/10 minutes; the number of unstable terminal groups was below the detection limit.

### Test Example 2

Using the pellets after fluorination reaction as obtained in Example 2 or Comparative Production Example 4, pressed sheets were prepared in the same manner as in Test Example 1 and submitted to electrical characteristic (dielectric loss tangent) measurement and MIT testing. The results are shown in Table 2.

TABLE 2

| | | | Comparative |
|---|---|---|---|
| | | | Production |
| | | Example 2 | Example 4 |
| PPVE(% by mass) | | 5.8 | 4.6 |
| Tm(° C.) | | 302 | 302 |
| MFR(g/10 min) | 372° C. | 30.9 | 31.0 |
| Number of unstable terminal groups | | below detection | below detection |
| per 1 × 10⁶ carbon atoms | | limit | limit |
| Dielectric loss tangent [2.45 GHz] | | 3.6 × 10⁻⁴ | 3.6 × 10⁻⁴ |
| MIT folding endurance [×10⁴ cycles] | | 3.0 | 0.6 |
| attenuation of cable | 6 GHz | 1.2 | — |
| (dB/m) | 10 GHz | 1.6 | — |

### Example 3

A glass-lined autoclave (capacity: 174 L) equipped with a stirrer was charged with 46.1 kg of pure water. After sufficient purging of the inside gas with N₂, the autoclave was evacuated and charged with 40.7 kg of C-318, 6.1 kg of methanol and 2.8 kg of PPVE. Then, the autoclave inside was maintained at 35° C. with stirring, TFE was fed thereinto under pressure until arrival of the inside pressure at 0.64 MPaG. The polymerization was initiated by adding 0.081 kg of a 50% methanol solution of NPP as a polymerization initiator. Since otherwise the pressure would drop with the progress of the polymerization, additional TFE and PPVE were continuously fed in a ratio such that the desired polymer composition might be obtained.

After 19 hours from the start of polymerization, the stirring was discontinued and, at the same time, the unreacted monomers and C-318 were discharged to thereby terminate the polymerization. The white powder in the autoclave was washed with water and dried at 150° C. for 12 hours to give a polymer product.

The above polymer product was pelletized at an extrusion temperature of 370° C. The pellets obtained had the following copolymer composition, melting point, MFR (measuring temperature 372° C.) and number of unstable terminal groups per 1×10⁶ carbon atoms.
Copolymer composition: TFE/PPVE=93.0/7.0 (% by mass)
Tm: 300° C.
MFR: 69.7 g/10 minutes
Number of unstable terminal groups: 170 —CH₂OH groups, 21 —COF groups, 3 —COOH groups (unassociated), 64 —COOCH₃ groups and 2 —COOH groups (associated)

The pellets obtained were subjected to fluorination reaction in the same manner as in Example 1. The pellets after fluorination reaction had an MFR (measuring temperature 372° C.) of 72.8 g/10 minutes; the number of unstable terminal groups was below the detection limit.

The pellets after fluorination (100 parts by mass) and 2 parts by mass of boron nitride [BN] as a nucleating agent were fed into a twin-screw kneader (product of Ikegai Corporation) and kneaded and extruded at 370° C. to give a resin mixture.

This resin mixture was fed into an electric wire covering molding machine (product of Hijiri Manufacturing) and foaming covering molding was carried out while injecting N₂ as a blowing agent.

A 0.080 mm ø (AWG 40) silver-plated copper wire was covered to a covering layer thickness of 0.090 mm t so that the characteristic impedance might amount to 50Ω. This covered wire was jacketed with an about 0.2-mm-thick copper pipe to give a semirigid cable.

The pellets of Example 3 after fluorination reaction were found to be better in moldability as compared with Comparative Example 1 and Example 2 and capable of covering thinner electric wires.

The semirigid cable obtained was measured for attenuation in the same manner as in Comparative Example 1. The measurement results are shown in Table 3. When no nucleating agent was added and the electric wire was covered without foaming, the semirigid cable obtained showed an attenuation of 11.6 dB/m at 6 GHz or 16.1 dB/m at 10 GHz.

### Test Example 3

Using the pellets after fluorination reaction as obtained in Example 3, pressed sheets were prepared in the same manner as in Test Example 1 and submitted to electrical characteristic (dielectric loss tangent) measurement and MIT testing. The results are shown in Table 3.

TABLE 3

| | | Example 3 |
|---|---|---|
| PPVE(% by mass) | | 7.0 |
| Tm(° C.) | | 300 |
| MFR(g/10 min) | 372° C. | 72.8 |
| Number of unstable terminal groups | | below detection |
| per 1 × 10⁶ carbon atoms | | limit |
| Dielectric loss tangent [2.45 GHz] | | 3.7 × 10⁻⁴ |
| MIT folding endurance [×10⁴ cycles] | | 0.6 |
| attenuation of cable | 6 GHz | 8.2 |
| (dB/m) | 10 GHz | 10.7 |

The pellets of Example 3 after fluorination reaction were found to be applicable as a covering material for thin electric wires and excellent in electrical characteristics even in the case of application thereof in covering thin electric wires. Further, they were found to have a high MIT value for their high MFR and good moldability and be excellent in crack resistance as well in comparison with the prior art TFE-based copolymers comparable in MFR thereto.

### Comparative Production Example 5

A glass-lined autoclave (capacity: 174 L) equipped with a stirrer was charged with 51.1 kg of pure water. After sufficient purging of the inside gas with N₂, the autoclave was evacuated and charged with 34.7 kg of C-318 and 10.4 kg of perfluoro (methyl vinyl ether) [PMVE]. Then, the autoclave inside was maintained at 35° C. with stirring, TFE was fed thereinto under pressure until arrival of the inside pressure at 0.79 MPaG. The polymerization was initiated by adding 0.38 kg of a 50% methanol solution of NPP as a polymerization initiator. Since otherwise the pressure would drop with the progress of the polymerization, additional TFE and PMVE were continuously fed in a ratio such that the desired polymer composition might be obtained.

After 30 hours from the start of polymerization, the stirring was discontinued and, at the same time, the unreacted monomers and C-318 were discharged to thereby terminate the polymerization. The white powder in the autoclave was washed with water and dried at 150° C. for 12 hours to give a polymer product.

The polymer product obtained was melt-extruded through a screw extruder (product of Ikegai Corporation) at an extrusion temperature of 265° C. to give TFE-based copolymer pellets.

The pellets obtained had the following copolymer composition, melting point and MFR (measuring temperature 265° C.).
Copolymer composition: TFE/PMVE=80.2/19.8 (% by mass)
Melting point [Tm]: 226° C.
MFR: 15.0 g/10 minutes

The pellets obtained were subjected to fluorination reaction in the same manner as in Example 1 except that the reaction temperature was 190° C. The pellets after fluorination reaction had an MFR (measuring temperature 265° C.) of 16.9 g/10 minutes; the number of unstable terminal groups was below the detection limit.

### Comparative Production Example 6

A glass-lined autoclave (capacity: 174 L) equipped with a stirrer was charged with 51.3 kg of pure water. After sufficient purging of the inside gas with N₂, the autoclave was evacuated and charged with 41.3 kg of C-318 and 5.3 kg of PMVE. Then, the autoclave inside was maintained at 35° C. with stirring, TFE was fed thereinto under pressure until arrival of the inside pressure at 0.79 MPaG. The polymerization was initiated by adding 0.47 kg of a 50% methanol solution of NPP as a polymerization initiator. Since otherwise the pressure would drop with the progress of the polymerization, additional TFE and PMVE were continuously fed in a ratio such that the desired polymer composition might be obtained.

After 12 hours from the start of polymerization, the stirring was discontinued and, at the same time, the unreacted monomers and C-318 were discharged to thereby terminate the polymerization. The white powder in the autoclave was washed with water and dried at 150° C. for 12 hours to give a polymer product.

The polymer product obtained was melt-extruded through a screw extruder (product of Ikegai Corporation) at an extrusion temperature of 320° C. to give TFE-based copolymer pellets.

The pellets obtained had the following copolymer composition, melting point and MFR (measuring temperature 372° C.).
Copolymer composition: TFE/PMVE=88.2/11.8 (% by mass)
Melting point [Tm]: 253° C.
MFR: 30.5 g/10 minutes

The pellets obtained were subjected to fluorination reaction in the same manner as in Example 1 except that the reaction temperature was 190° C. The pellets after fluorination reaction had an MFR (measuring temperature 372° C.) of 32.3 g/10 minutes; the number of unstable terminal groups was below the detection limit.

### Example 5

A glass-lined autoclave (capacity: 174 L) equipped with a stirrer was charged with 41.5 kg of pure water. After sufficient purging of the inside gas with N₂, the autoclave was evacuated and charged with 106.3 kg of C-318 and 4.8 kg of PMVE. Then, the autoclave inside was maintained at 35° C. with stirring, TFE was fed thereinto under pressure until arrival of the inside pressure at 0.60 MPaG. The polymerization was initiated by adding 0.63 kg of a 50% methanol solution of NPP as a polymerization initiator. Since otherwise the pressure would drop with the progress of the polymerization, additional TFE and PMVE were continuously fed in a ratio such that the desired polymer composition might be obtained.

After 8 hours from the start of polymerization, the stirring was discontinued and, at the same time, the unreacted monomers and C-318 were discharged to thereby terminate the polymerization. The white powder in the autoclave was washed with water and dried at 150° C. for 12 hours to give a polymer product.

The polymer product obtained was melt-extruded through a screw extruder (product of Ikegai Corporation) at an extrusion temperature of 350° C. to give TFE-based copolymer pellets.

The pellets obtained had the following copolymer composition, melting point and MFR (measuring temperature 372° C.).
Copolymer composition: TFE/PMVE=92.1/7.9 (% by mass)
Melting point [Tm]: 278° C.
MFR: 19.8 g/10 minutes

The pellets obtained were subjected to fluorination reaction in the same manner as in Example 1 except that the reaction temperature was 190° C. The pellets after fluorination reaction had an MFR (measuring temperature 372° C.) of 21.4 g/10 minutes; the number of unstable terminal groups was below the detection limit.

Using a 30 mm ø electric wire covering molding machine, the pellets subjected to fluorination reaction were submitted to covering/molding. Electric wire covering was carried out using the pellets obtained, under the same conditions as in Comparative Example 1 except that the take-off speed was 7.4 m/minute to give a semirigid cable. The semirigid cable obtained was measured for attenuation using a model HP8510C network analyzer (product of Hewlett Packard). The semirigid cable obtained showed an attenuation of 1.3 dB/m at 6 GHz or 1.8 dB/m at 10 GHz.

### Test Example 4

Using the pellets after fluorination reaction as obtained in Comparative Production Example 5 or 6 or Example 5, pressed sheets were prepared in the same manner as in Test Example 1 and submitted to electrical characteristic (dielectric loss tangent) measurement and MIT testing. The results are shown in Table 4.

TABLE 4

| | | Comparative | Comparative | |
|---|---|---|---|---|
| | | Production | Production | |
| | | Example 5 | Example 6 | Example 5 |
| PMVE(% by mass) | | 19.8 | 11.8 | 7.9 |
| Tm(° C.) | | 226 | 253 | 278 |
| MFR(g/10 min) | 372° C. | 16.9 | 32.3 | 21.4 |
| Number of unstable terminal groups | | below detection | below detection | below detection |
| per 1 × 10⁶ carbon atoms | | limit | limit | limit |
| Dielectric loss tangent [2.45 GHz] | | 4.9 × 10⁻⁴ | 4.4 × 10⁻⁴ | 3.9 × 10⁻⁴ |
| MIT folding endurance [×10⁴ cycles] | | 2.5 | 0.7 | 0.8 |
| attenuation of cable | 6 GHz | — | — | 1.3 |
| (dB/m) | 10 GHz | — | — | 1.8 |

Measured at a temperature of 265° C.

### INDUSTRIAL APPLICABILITY

The covered electric wire of the invention shows low levels of attenuation even in the case of transmission of high frequency electromagnetic waves and, therefore, can be applied in various filed of utilization, for example in a circuit for high frequency transmission, as a coaxial cable for a base station or like communication system, a LAN cable, a flat cable or a like cable, and in such a high frequency transmission device as a small sized electronic device in a mobile phone or as a printed circuit board.

1. A covered electric wire comprising a core wire covered with a tetrafluoroethylene [TFE]-based copolymer comprising TFE-derived TFE units and perfluoro(alkyl vinyl ether) [PAVE]-derived PAVE units,
a content of said PAVE unit being in excess of 5% by mass and not higher than 20% by mass relative to all monomer units, containing less than 10 unstable terminal groups per 1×10⁶ carbon atoms,
and having a melting point of not lower than 260° C.

2. The covered electric wire according to claim 1,
wherein the TFE-based copolymer has a PAVE unit content exceeding 5% by mass and lower than 8% by mass relative to all monomer units.

3. The covered electric wire according to claim 1,
wherein the TFE-based copolymer comprises PAVE units derived from perfluoro(propyl vinyl ether) [PPVE] or perfluoro(methyl vinyl ether) [PMVE].

4. The covered electric wire according to claim 1,
wherein the TFE-based copolymer contains less than 5 unstable terminal groups per 1×10⁶ carbon atoms.

5. The covered electric wire according to claim 1,
wherein the TFE-based copolymer has a melt flow rate of not higher than 60 g/10 minutes.

6. The covered electric wire according to claim 1,
wherein the TFE-based copolymer has a melt flow rate of not higher than 35 g/10 minutes.

7. The covered electric wire according to claim 1,
wherein the TFE-based copolymer covering layer is a foamed body.

8. A coaxial cable,
wherein a covered electric wire according to claim 1 is further covered with an outer layer.
